(19) United States
(12) Patent Application Publication
(10) Pub. No.: US 2018/0238617 A1
(43) Pub. Date: Aug. 23, 2018

(54) PARTIAL RELIQUEFACTION SYSTEM

(71) Applicant: Atlas Copco Comptec, LLC, Voorheesville, NY (US)

(72) Inventor: Todd Steven Abbot Gibbs, Amsterdam, NY (US)

(21) Appl. No.: 15/900,040

(22) Filed: Feb. 20, 2018

Related U.S. Application Data
(60) Provisional application No. 62/460,958, filed on Feb. 20, 2017.

(51) Int. Cl. F25J 1/00; F17C 9/02; F25J 1/02

(52) U.S. Cl. CPC F25J 1/0025; F25J 2290/72; F25J 1/004; F25J 1/0202; F25J 1/0296; F25J 1/023; F25J 1/0277; F17C 2221/033; F17C 2227/0157; F17C 2227/0302; F17C 2227/0339; F17C 2265/038; F17C 2227/0388; F25J 2290/12; F25J 2210/06; F17C 9/02

(57) ABSTRACT

Provided is a partial reliquefaction system including a boil-off gas (BOG) compression system receiving a BOG exiting from a liquefied natural gas (LNG) storage tank, a high-pressure compression section receiving a BOG stream from the BOG compression system, a heat exchanger effectuating a temperature drop of the BOG stream, an expander receiving the cooled BOG stream after passing through the heat exchanger, and a separator vessel for receiving a gas/liquid mixture, wherein a gas portion of the gas/liquid mixture is recirculated through the heat exchanger to act as the cooling medium for the heat exchanger.

### CROSS-REFERENCE TO RELATED CASES

This application claims priority to and the benefit of U.S. Provisional Application No. 62/460,958, filed Feb. 20, 2017, and entitled “Partial Reliquefaction System.”

### FIELD OF TECHNOLOGY

The following relates to a partial reliquefaction system and method, and more specifically to embodiments of a partial reliquefaction loop of a partial reliquefaction system for onboard a LNG carrier.

### BACKGROUND

Liquefied natural gas (LNG) may be produced by cooling natural gas into a liquid state using cryogenic cooling techniques. By condensing the natural gas into a liquid, the LNG may be stored in tanks, maintained as a liquid, and transported over distances to a desired destination, where the LNG can be re-gasified.

Typically, storage tanks on an LNG carrier may be equipped with a thermal insulation structure. Despite the thermal insulation structure, it may be difficult to completely prevent heat ingression into the insulated storage tanks. As a result of the natural ingress of heat through the insulated storage tanks, a portion of the stored LNG may be vaporized, generating boil-off gas (BOG) in the LNG storage tank during LNG transportation.

A conventional LNG carrier may employ a propulsion engine or generators that may be driven by burning off BOG. In the instances where more BOG is being produced than is being consumed by the main engines or the generators, it may be possible to increase the economic value of the BOG by recycling it back to the insulated storage tank for later use. For this purpose, reliquefaction systems may be commonly installed on the LNG carrier to return the unused BOG back to the insulated storage tank as the LNG.

Current reliquefaction systems may include an insulated storage tank containing the LNG, where the BOG may be removed from the insulated storage tank by use of a BOG compressor. The BOG may be cooled and condensed into the LNG in a cryogenic heat exchanger (e.g. cold box) by use of a high-pressure compressor with a Joule-Thompson (JT) valve, or a secondary cooling loop for larger systems. Non-condensable items may be removed in a separator vessel. From the separator, the LNG may be returned to the insulated storage tank by differential pressure in the system. However, these methods may be costly, and requires a secondary cooling loop, or utilizes very high pressures which often require oil flooded compression in the compression stream.

### SUMMARY

A first aspect relates to a partial reliquefaction system comprising: a boil-off gas (BOG) compression system receiving a BOG exiting from a liquefied natural gas (LNG) storage tank, a high-pressure compression section receiving a BOG stream from the BOG compression system, a heat exchanger effectuating a temperature drop of the BOG stream, an expander receiving the cooled BOG stream after passing through the heat exchanger, and a separator vessel for receiving a gas/liquid mixture, wherein a gas portion of the gas/liquid mixture is recirculated through the heat exchanger to act as the cooling medium for the heat exchanger.

A second aspect relates to a partial reliquefaction system comprising: a boil-off gas (BOG) compression system receiving a BOG exiting a liquefied natural gas (LNG) storage tank, a first valve controlling a flow of a BOG stream to an engine for consumption in a first configuration, and to a partial reliquefaction loop in a second configuration, an oil-free high-pressure compression section of the partial reliquefaction loop connected to the valve via a first conduit for compressing the BOG stream to increase a pressure of the BOG stream, an expander connected to the high-pressure compression section, wherein the BOG stream passes through a water-to-gas heat exchanger to effectuate a first temperature reduction, and a gas-to-gas heat exchanger to effectuate a second temperature reduction, prior to reaching the expander, a separator vessel connected to the expander, the separator vessel receiving a gas/liquid mix of the BOG stream from the expander, a recirculation conduit connecting a gas outlet of the separator vessel to the gas-to-gas heat exchanger, wherein a recirculated BOG from the separator vessel acts as a cooling medium of the gas-to-gas heat exchanger to effectuate the second temperature reduction to cool the BOG stream to below −50° C. prior to entering the expander, an oil-free low-pressure compression section for receiving the recirculated BOG, wherein the recirculated BOG exiting the oil-free low-pressure compression section is delivered to a second valve, the second valve controlling the flow of the recirculated BOG to the engine for consumption in a first configuration, and back to through the partial reliquefaction loop in a second configuration.

A third aspect relates to a method for partial reliquefaction of a boil-off gas (BOG) on a liquified natural gas (LNG) carrier, the method comprising: capturing the BOG exiting a LNG storage tank and delivering to a BOG compressor, compressing a BOG stream delivered by the BOG compressor using a high-pressure compressor to increase a pressure and of the BOG stream, reducing the temperature of the BOG stream using a heat exchanger, directing the BOG stream to pass through an expander, which produces a gas/liquid mixture of the BOG stream, separating a gas portion of the gas/liquid mixture from a liquid portion of the gas/liquid mixture in a separator vessel, and recirculating the gas portion through the heat exchanger, such that a recirculated BOG acts as a cooling medium for the heat exchanger.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a BOG compression system;

FIG. 2 depicts a detailed schematic view of a partial reliquefaction system, in accordance with embodiments of the present invention;

FIG. 3 depicts a schematic view of the partial reliquefaction system and the BOG compressor, in accordance with embodiments of the present invention;

FIG. 4 depicts a schematic view of a partial reliquefaction system having a pre-cooling feature, in accordance with embodiments of the present invention.

### DETAILED DESCRIPTION

A detailed description of the hereinafter described embodiments of the disclosed apparatus, method, and system are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

Embodiments of the present invention may include an insulated storage tank containing liquefied natural gas (LNG), where boil-off gas (BOG) may be removed from the insulated storage tank by use of a BOG compressor. The BOG may be cooled and condensed into LNG without use of a cooling loop and at reduced pressures as compared to systems that utilize a Joules Thompson (JT) valve, thus avoiding the need for oil flooded compression. A two-section booster compressor and a turbo expander (e.g., a reliquefaction loop) may be used to transport the supply of the LNG, to an XDF engine, or with use of an additional booster compressor, feed gas to higher pressure engines such as a ME-GI engine. Use of the two-section booster compressor and the turbo expander (e.g., the reliquefaction loop) may result in an enhanced efficiency and a reduced capital expenditure (CAPEX) from a typical system. Further, the system of this disclosure may present an oil-free solution to traditional systems.

Embodiments of the present invention may include a reliquefaction system for a liquefied natural gas (LNG) carrier. The reliquefaction system for the LNG carrier may display features and components, such as one or more insulated LNG storage tanks that may be configured to maintain the LNG being transported by the LNG carrier in a liquid state. LNG (as well as other LPGs) may be stored and transported at temperatures below ambient levels. The one or more storage tanks may be equipped with a thermal insulation structure. Despite the thermal insulation structure, a natural ingress of heat through the one or more storage tanks may occur, where a portion of the stored LNG may be vaporized and may generate boil-off gas (BOG) in the LNG storage tank during LNG transportation.

Embodiments of the present invention may utilize the system that is in place to feed the engine along with the addition of a two-section booster compressor and a turbo expander. This can be a direct reliquefaction loop that will also allow for the supply of gas to an XDF engine or other engine systems such as the MEGI engine with the use of an additional booster engine. The benefit of this system can be reduced CAPEX from the traditional system with improved efficiency over a JT valve based system without the negative effects of oil in the compression stream. Furthermore, embodiments of the present invention may be optimized for 1-2 ton/hr reliquefaction, wherein pressures are limited to allow for 100% oil free compression. Embodiments of the present invention may eliminate the secondary cooling loop found on current reliquefaction systems. Further, engine supply pressure is maintained.

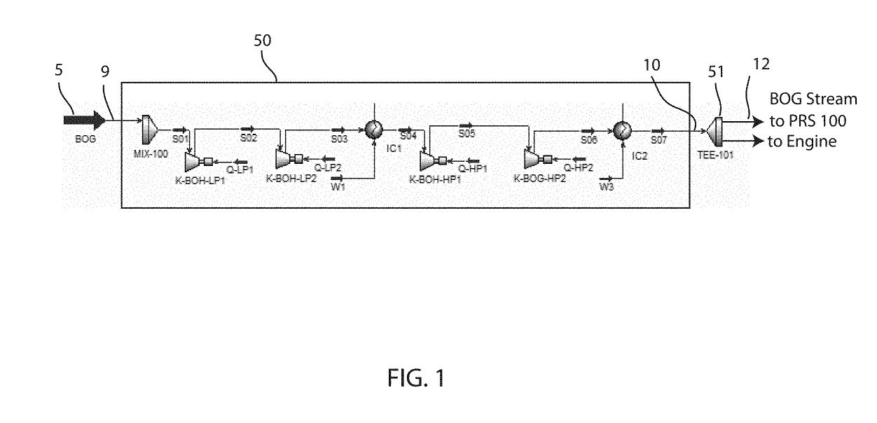

Referring now to the drawings, FIG. 1 depicts a BOG compression system 50. Embodiments of the BOG compression system 50 may receive BOG 5 from a storage tank storing LNG, via conduit 9. Embodiments of conduit 9 may be a pipe, a line, a connection, tubing, a duct, a fluidic connection, a pathway, and the like, for directing, receiving, advancing, facilitating, etc. a flow of a fluid (e.g. BOG). The conduit 9 may fluidically connect the LNG storage tank to the compressor system 50 to an engine of the LNG carrier. The BOG 5 may be received by the BOG compression system 50 to compress the BOG 5 using a multi-stage compressor unit. Embodiments of the BOG compression system 50 may be a BOG compressor, such as a centrifugal compressor, positive displacement compressor, cryogenic compressor, non-cryogenic compressor, or any type of BOG compressor. Embodiments of the BOG compressor may be a single stage compressor or a multi-stage compressor, such as a four-stage compressor. A resultant BOG stream may exit the BOG compression system 50 via conduit 10 and enter a valve 51, which may divide, control, direct, split, or otherwise provide at least two separate fluid paths for the BOG stream. Embodiments of conduit 10 may be a pipe, a line, a connection, tubing, a duct, a fluidic connection, a pathway, and the like, for directing, receiving, advancing, facilitating, etc. a flow of a fluid (e.g. BOG stream). The conduit 11 may fluidically connect the BOG compressor system 50 to valve 51.

Embodiments of the valve 51 may be a three-way valve, a tee-shaped divider, a divider, a mixing valve, and the like. One or more additional valves may be disposed proximate the valve 51 to control the flow path of the BOG stream from the valve 51. In a first configuration, the BOG stream may continue to an engine for consumption by the engine, such as an engine of a LNG carrier. For instance, a flow of the BOG stream may be controlled, using valve 51, to direct or otherwise allow the BOG stream to flow towards an engine of an LNG carrier, such as an XDF engine or ME-GI engine. In a second configuration, the BOG stream may continue to a partial reliquefaction system (PRS) 100. For instance, a flow of the BOG stream may be controlled, using valve 51, to direct or otherwise allow the BOG stream to flow towards PRS 100. In an exemplary embodiment, in the second configuration, the BOG stream may be passed or otherwise advanced to a partial reliquefaction loop of the PRS 100. In further exemplary embodiments, in the second configuration, the BOG stream may be controlled or otherwise directed to a high compression stage of the PRS 100.

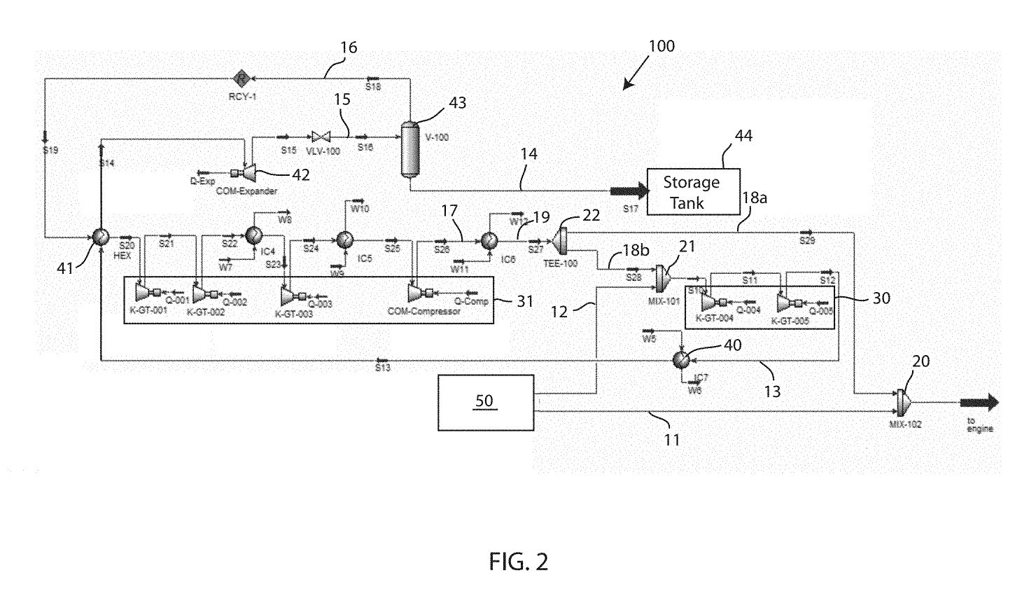

FIG. 2 depicts a detailed schematic view of a PRS 100, in accordance with embodiments of the present invention. Embodiments of PRS 100 may be a partial reliquefaction system for both reliquefaction of BOG and for providing BOG back for consumption by an engine. Embodiments of the PRS 100 may be a single system, including a compressor-expander combined system. In the combined compressor-expander system, more than one compression sections may be utilized. In alternative embodiments, the PRS 100 may include more than expander 42 and more than one separator vessel 43. Furthermore, embodiments of the PRS 100 may eliminate a need for a secondary cooling loop to cool the BOG stream flowing through the PRS 100. In addition, embodiments of the PRS 100 may utilize oil-free compressors due to the PRS 100 being operated at very low temperatures and/or reduced pressures. Oil-flooded compressors tend to contaminate the liquid cargo in current systems, and thus the PRS 100 operating at reduced pressure and low temperature allows the use of oil-free compressors, avoiding contamination issues.

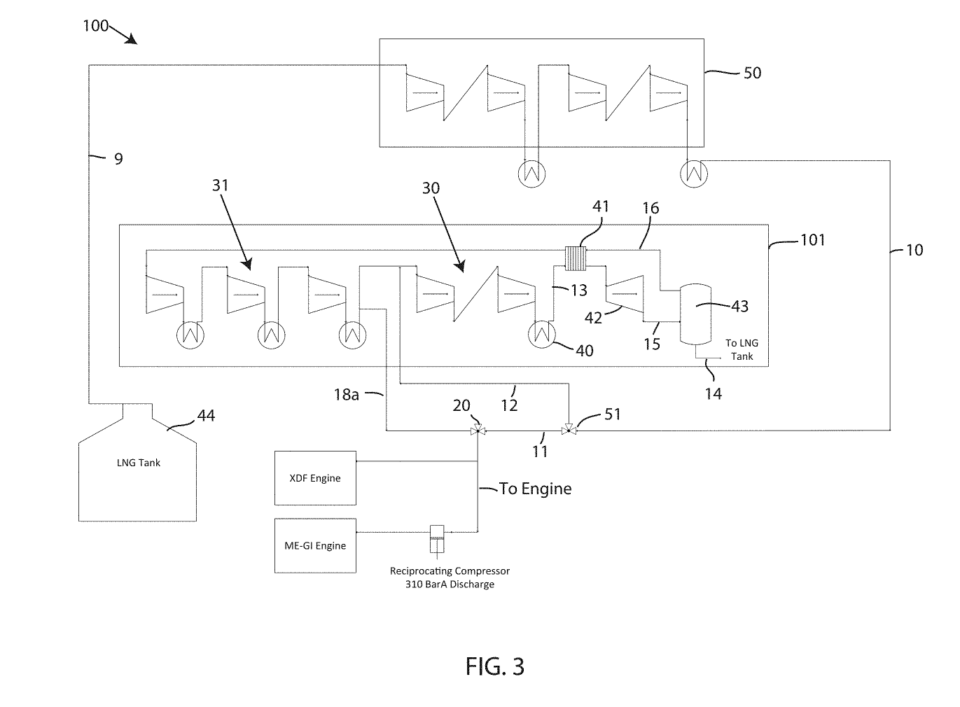

With additional reference to FIG. 3, which depicts a schematic view of the PRS 100 and the BOG compressor 50, in accordance with embodiments of the present invention, an operation of the PRS 100 will now be described. Valve 51 may be automatically controlled, opened, closed, switched, etc. via a computing unit, processor, etc., or may be manually controlled to determine which path the BOG stream takes. In a first configuration of valve 51, the BOG stream may continue via conduit 11 to an engine of a LNG carrier, or other engine system that may consume BOG as fuel for operating an engine. Embodiments of conduit 11 may be a pipe, a line, a connection, tubing, a duct, a fluidic connection, a pathway, and the like, for directing, receiving, advancing, facilitating, etc. a flow of a fluid (e.g. BOG stream). The conduit 11 may fluidically connect the BOG compressor system 50 to an engine of the LNG carrier. For instance, the BOG stream may exit the BOG compression system 50 and, in the first configuration of valve 51, flow to valve 20, which controls a flow to the engine. Embodiments of valve 20 may be a three-way valve, a tee-shaped divider, a divider, a mixing valve, and the like. One or more additional valves may be disposed proximate the valve 20 to control the flow path of the BOG stream from the valve 20.

In a second configuration of the valve 51, the BOG stream may instead flow through conduit 12 to a partial reliquefaction loop 101 of the PRS 100. Embodiments of conduit 12 may be a pipe, a line, a connection, tubing, a duct, a fluidic connection, a pathway, and the like, for directing, receiving, advancing, facilitating, etc. a flow of a fluid (e.g. BOG stream). Embodiments of conduit 12 may connect the BOG compression system 50 to the high-pressure compression section 30. The BOG stream flowing through conduit 12 may enter a high-pressure compression section 30 of the PRS 100. A valve 21 may control a flow of the BOG stream from the BOG compressor 50 to the high-pressure compression section 30. Embodiments of the valve 21 may be a three-way valve, a tee-shaped divider, a divider, a mixing valve, and the like. One or more additional valves may be disposed proximate the valve 21 to control the flow path of the BOG stream from the valve 21. Moreover, embodiments of the high-pressure compression section 30 may comprise a compressor of various compression stages. For example, embodiments of the high-pressure compression section 30 may be a single stage compressor, a two-stage compressor, a three-stage compressor, or any multi-stage compressor. Embodiments of the high-pressure compression section 30 may also be a centrifugal compressor, or a positive displacement compressor. In an exemplary embodiment, the high-pressure compression section 30 may include an oil-free compressor, such that a risk of oil contaminating the liquid cargo (e.g. LNG) may be eliminated. The oil-free compressor(s) of the high-pressure compression section 30 may be used due to the PRS 100 operating at low temperatures and/or reduced pressures. For instance, a pressure of the BOG stream operating near atmospheric pressure and may range in temperature from −163° C. to +30° C. as the BOG stream enters the initial BOG compressor. As the BOG stream flows through conduit 12 to the high-pressure compression section 30 may range from 7 to 17 Bar, and a temperature of the BOG stream may range from 0 to 50° C., and a temperature of the PRS 100 at the high-pressure compression section 30 may range from 50 to 200° C. in conduit 13 prior to cooling. The high-pressure compression section 30 of the partial reliquefaction loop 101 of the PRS 100 may receive the BOG stream from the BOG compression system 50 through conduit 12, and may compress the BOG stream to increase the temperature and a pressure of the BOG stream. For example, the high-pressure compression section 30 may increase the temperature of the BOG stream from 50° C. to 150° C. and increase a pressure from 17 Bar to 45 Bar. The BOG stream, being cooled by high-pressure compressor section 30, may exit the high-pressure compression section 30 flow through conduit 13. Embodiments of conduit 13 may be a pipe, a line, a connection, tubing, a duct, a fluidic connection, a pathway, and the like, for directing, receiving, advancing, facilitating, etc. a flow of a fluid (e.g. BOG stream). The conduit 13 may fluidically connect the high-pressure compression section 30 to an expander 42 of the PRS 100. In some embodiments, the BOG stream, after exiting the high-pressure compression section 30, may flow through conduit 13 and pass through a first heat exchanger 40. Embodiments of the first heat exchanger 40 may be a heat exchanger, a cooler, a pre-cooler, a water-to-gas heat exchanger, and the like. The first heat exchanger 40 may reduce a temperature of the BOG stream from about 150° C. to about 40° C. A pressure of the BOG stream after passing through the first heat exchanger 40 may be 40 Bar to 50 Bar.

The BOG steam 12 may continue to flow through conduit 13 and pass through a second heat exchanger 41. Embodiments of the second heat exchanger 41 may be a heat exchanger, a cooler, a pre-cooler, a gas-to-gas heat exchanger, and the like. The first heat exchanger 40 may reduce a temperature of the BOG stream from about 40° C. to about −80° C. A pressure of the BOG stream after passing through the first heat exchanger 40 may be 40 Bar-50 Bar. The low temperature, BOG stream may continue flowing toward the expander 42. A max pressure at an inlet of the expander 42 may be around 45 bar. Embodiments of the expander 42 may be an expander, a turboexpander, an expansion turbine, and the like. An expander, such as expander 42, may be useful in PRS 100 because the expander is a more efficient means of liquefying a BOG stream. The expander allows PRS 100 to operate at much lower pressures (e.g. 40-50 bar). Systems that operate without an expander and only a JT valve typically operate at 100 bar or higher. The BOG stream may enter the expander 42, which may result in a partial reliquefaction of the BOG stream. For instance, the BOG stream may leave the expander 42 as a gas/liquid mixture. The gas/liquid mixture may flow through conduit 15 to the separator vessel 43. Embodiments of conduit 15 may be a pipe, a line, a connection, tubing, a duct, a fluidic connection, a pathway, and the like, for directing, receiving, advancing, facilitating, etc. a flow of a fluid (e.g. gas/liquid mixture). The conduit 15 may fluidically connect the expander 42 to the separator vessel 43 of the PRS 100. Embodiments of the separator vessel 43 may be a separator, a vapor-liquid separator, a gas-liquid separator, a separator tank, a gas-liquid separation tank, and the like. Embodiments of the separator vessel 43 may include a feed inlet connected to conduit 15 that may extend into an interior of the separator vessel 43 to deliver the gas/liquid mixture from the expander 42. Moreover, embodiments of the separator vessel 43 may include a liquid outlet and a gas outlet. In an exemplary embodiment, the liquid outlet may be located proximate a bottom of the separator vessel 43, while the gas outlet may be located proximate a top of the separator vessel 43. Inside the separator vessel 43, the gas/liquid mixture may be separated such that a gas portion travels toward the gas outlet of the separator 43 and a liquid portion settles at the bottom of the separator vessel 43. The liquid portion that settles in the separator vessel 43 may be liquefied natural gas, and may be directed out through the liquid outlet to conduit 14. Embodiments of conduit 14 may be a pipe, a line, a connection, tubing, a duct, a fluidic connection, a pathway, and the like, for directing, receiving, advancing, facilitating, etc. a flow of liquid (e.g. LNG). The conduit 15 may fluidically connect the separator vessel 43 of the PRS 100 to a storage tank 44. Embodiments of the storage tank 44 may be a LNG storage tank, vessel, container, etc.

The gas portion leaving the separator vessel 43 may be recirculated through portions of the PRS 100. For instance, BOG may be recirculated through recirculation conduit 16. Embodiments of recirculation conduit 16 may be a pipe, a line, a connection, tubing, a duct, a fluidic connection, a pathway, and the like, for directing, receiving, advancing, facilitating, etc. a flow of a fluid (e.g. recirculated BOG). The conduit 16 may fluidically connect the separator vessel 43 to a low-pressure compression section 31 of the PRS 100. The recirculated BOG may have a temperature range of −150° C. to −163° C. and a pressure of 1 BarA to 2 BarA, when exiting the separator vessel 43. The recirculated BOG (e.g. a gas portion of the gas/liquid mixture) may be recirculated through the heat exchanger 41 to act as the cooling medium for the heat exchanger 41. For example, the cold recirculated BOG flowing through conduit 16 may pass through the heat exchanger 41 to provide a cooling means for cooling the BOG stream flowing through conduit 13, which has exited the high-pressure compression section 30 and optionally a first heat exchanger 40. The recirculated BOG may cool the BOG stream prior to entering the expander 42, such that additional or secondary cooling loops can be avoided. Utilizing the recirculated BOG as a cooling medium for the second heat exchanger 41 provides the necessary cooling effect to reduce a temperature and/or a pressure of the BOG stream for use with an expander 42 to separate the BOG stream into a gas/liquid mixture. The recirculated BOG used to cool the BOG stream avoids other costly or more complex and inefficient methods to cool the BOG stream, such as using cooling and condensing the BOG stream into LNG in a cryogenic heat exchanger (e.g. cold box) by use of a high-pressure compressor with a Joule-Thompson (JT) valve, or a secondary cooling loop for larger systems.

Referring still to FIGS. 2 and 3, the recirculated BOG may flow via conduit 16 to the low-pressure compression stage 31. Embodiments of the low-pressure compression section 31 may comprise a compressor of various compression stages. For example, embodiments of the low-pressure compression section 31 may be a single stage compressor, a two-stage compressor, a three-stage compressor, or any multi-stage compressor. Embodiments of the low-pressure compression section 31 may also be a centrifugal compressor, or a positive displacement compressor. In an exemplary embodiment, the low-pressure compression section 31 may include an oil-free compressor, such that a risk of oil contaminating the liquid cargo (e.g. LNG) may be eliminated. The oil-free compressor(s) of the low-pressure compression section 31 may be used due to the PRS 100 operating at low temperatures and/or reduced pressures. For instance, a pressure of the recirculated BOG as the recirculated BOG enters the low-pressure compression section 31 may range from 1 BarA to 2 BarA, and a temperature of the recirculated BOG may range from −150° C. to −163° C.-, and a temperature of the PRS 100 at the low-pressure compression section 31 may range from 0° C. to 50° C. The low-pressure compression section 31 of the partial reliquefaction loop 101 of the PRS 100 may receive the recirculated BOG from the separator vessel 43, and may compress the recirculated BOG to increase the pressure of the recirculated BOG. For example, the low-pressure compression section 31 may increase the pressure from 1 BarA to 17 BarA.

The recirculated BOG may exit the low-pressure compression section 31 and flow through conduit 19 to valve 22. Embodiments of conduit 19 may be a pipe, a line, a connection, tubing, a duct, a fluidic connection, a pathway, and the like, for directing, receiving, advancing, facilitating, etc. a flow of a fluid (e.g. recirculated BOG). The conduit 19 may fluidically connect the low-pressure compression section 31 to valve 22. Embodiments of valve 22 may be a three-way valve, a tee-shaped divider, a divider, a mixing valve, and the like. One or more additional valves may be disposed proximate the valve 22 to control the flow path of the recirculated BOG from the valve 22. The recirculated BOG may exit the low-pressure compression section 31 and, in a first configuration of valve 22, flow to the engine via conduit 18a. Embodiments of conduit 18a may be a pipe, a line, a connection, tubing, a duct, a fluidic connection, a pathway, and the like, for directing, receiving, advancing, facilitating, etc. a flow of a fluid (e.g. recirculated BOG). The conduit 18a may fluidically connect the valve 22 to the engine components of an LNG carrier.

In a second configuration of the valve 22, the recirculated BOG may instead flow through conduit 18b to valve 21 of the partial reliquefaction loop 101 of the PRS 100. Embodiments of conduit 18b may be a pipe, a line, a connection, tubing, a duct, a fluidic connection, a pathway, and the like, for directing, receiving, advancing, facilitating, etc. a flow of a fluid (e.g. recirculated BOG). The conduit 18b may fluidically connect the valve 22 to the valve 21, for reinsertion into the partial reliquefaction loop 101 via the high-pressure compression section 30. The recirculated BOG may thus be combined with the BOG stream coming from the BOG compressor 50, and pass through the reliquefaction loop 101 of the PRS 100.

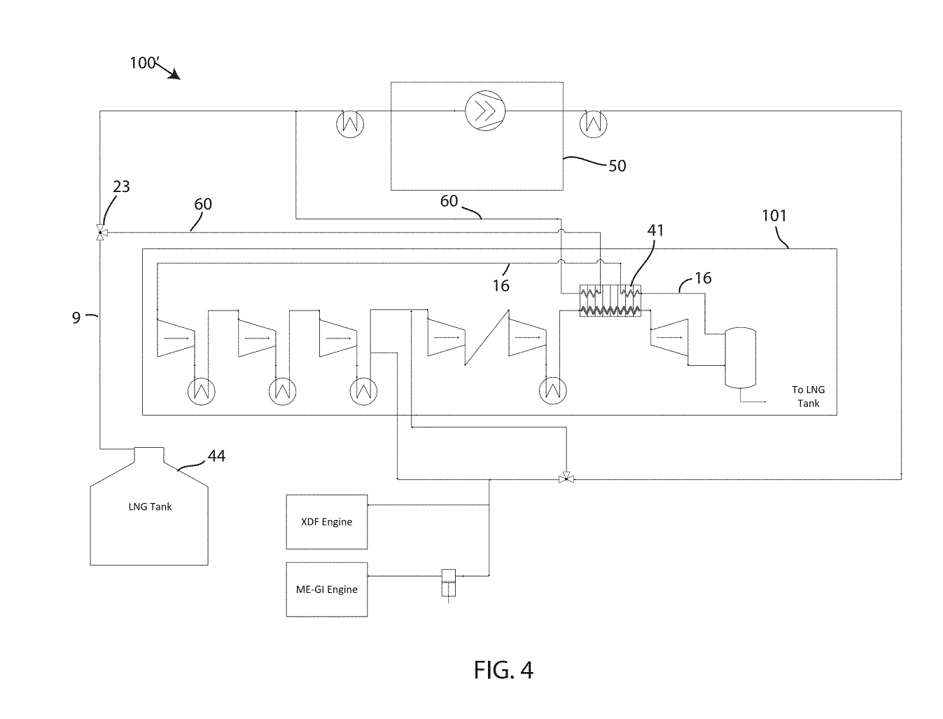

With continued reference to the drawings, FIG. 4 depicts a PRS 100′ having a pre-cooling feature, in accordance with embodiments of the present invention. Embodiments of the PRS 100′ may share the same or substantially the same features and functions as PRS 100 described above. However, embodiments of PRS 100′ may also include a pre-cooling feature that may help reduce a temperature of the BOG prior to final cooling in heat exchanger 41 prior to entering the expander 42. By increasing the temperature of the BOG prior to entering the BOG compressor 50, a non-cryogenic BOG compressor may be utilized, or a screw-type compressor may be utilized. Further, the lower temperature of the BOG as the BOG the final cooling in heat exchanger 41, the cooler the BOG stream entering expander 42 will be, thus increasing the amount of liquid and reducing the amount of gas that will be recycled through conduit 16. This may result inless work for the PRS 100′ to produce the desired amount of LNG.

To effectuate the pre-cooling feature of the PRS 100′, conduit 9 may include a valve 23. Embodiments of valve 23 may be a three-way valve, a tee-shaped divider, a divider, a mixing valve, and the like. One or more additional valves may be disposed proximate the valve 23 to control the flow path of the BOG from the storage tank 44. In a first configuration of valve 23, the flow of the BOG may continue to the BOG compression system 50 as described above. In a second configuration of valve 23, the BOG may instead flow through conduit 60 and pass through the second heat exchanger 41 before entering the BOG compression system 50. Embodiments of the conduit 60 may be a pipe, a line, a connection, tubing, a duct, a fluidic connection, a pathway, and the like, for directing, receiving, advancing, facilitating, etc. a flow of a fluid (e.g. BOG). The conduit 60 may fluidically connect the valve 23 to the BOG compression unit 50. Thus, BOG exiting the storage tank 44 may be directed to a gas-to-gas heat exchanger, such as heat exchanger 41, to be pre-heated prior to entering the BOG compression system 50.

Referring now to FIGS. 1-4, a method for partial reliquefaction of a boil-off gas (BOG) on a liquified natural gas (LNG) carrier may include the steps of capturing the BOG exiting a LNG storage tank 44 and delivering to a BOG compressor 50, compressing a BOG stream delivered by the BOG compressor 50 using a high-pressure compressor 30 to reduce a pressure and a temperature of the BOG stream, reducing the temperature of the BOG stream using a heat exchanger 41, 40, directing the BOG stream to pass through an expander 42, which produces a gas/liquid mixture of the BOG stream, separating a gas portion of the gas/liquid mixture from a liquid portion of the gas/liquid mixture in a separator vessel 43, and recirculating the gas portion through the heat exchanger 41, such that a recirculated BOG acts as a cooling medium for the heat exchanger 41. Embodiments of the method may further include the steps of directing a portion of the BOG leaving the LNG storage tank 44 to pass through the heat exchanger 41 before entering the BOG compressor 50, such that the BOG is pre-heated before entering the BOG compressor 50. Embodiments of the method may also include the step of compressing the recirculated BOG using a low-pressure compressor 31. Further embodiments of the method may include controlling a flow of the BOG stream, using a valve 51, to direct the BOG stream to an engine of the LNG carrier in a first configuration, and to the high-pressure compressor in a second configuration. Further embodiments of the method may also include controlling a flow of the recirculated BOG, using a valve 22, to direct the recirculated BOG to an engine of the LNG carrier in a first configuration, and to the high-pressure compressor 30 in a second configuration. The method may be performed at or below a max system pressure of 60 bar.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

1. A partial reliquefaction system comprising:
a boil-off gas (BOG) compression system receiving a BOG exiting from a liquefied natural gas (LNG) storage tank;
a high-pressure compression section receiving a BOG stream from the BOG compression system;
a heat exchanger effectuating a temperature drop of the BOG stream;
an expander receiving the cooled BOG stream after passing through the heat exchanger; and
a separator vessel for receiving a gas/liquid mixture;
wherein a gas portion of the gas/liquid mixture is recirculated through the heat exchanger to act as the cooling medium for the heat exchanger.

2. The partial reliquefaction system of claim 1, further comprising:
a low-pressure compression section receiving the recirculated BOG stream.

3. The partial reliquefaction system of claim 1, wherein the liquid portion is delivered to a LNG storage tank.

4. The partial reliquefaction system of claim 1, wherein the heat exchanger is a gas-to-gas heat exchanger that reduces a temperature of the BOG stream more than 100° C.

5. The partial reliquefaction system of claim 1, wherein the high-pressure compression section includes an oil-free compressor.

6. The partial reliquefaction system of claim 1, wherein a max system pressure is 60 bar.

7. The partial reliquefaction system of claim 1, wherein a max pressure at an inlet of the expander is below 60 bar.

8. The partial reliquefaction system of claim 1, wherein a portion of the BOG leaving the LNG storage tank is directed to pass through the heat exchanger before entering the BOG compression system, such that the BOG is pre-heated before entering the BOG compressor while providing additional pre-cooling before the expander.

9. A partial reliquefaction system comprising:
a boil-off gas (BOG) compression system receiving a BOG exiting a liquefied natural gas (LNG) storage tank;
a first valve controlling a flow of a BOG stream to an engine for consumption in a first configuration, and to a partial reliquefaction loop in a second configuration;
an oil-free high-pressure compression section of the partial reliquefaction loop connected to the valve via a first conduit for compressing the BOG stream to increase a pressure of the BOG stream;
an expander connected to the high-pressure compression section, wherein the BOG stream passes through a water-to-gas heat exchanger to effectuate a first temperature reduction, and a gas-to-gas heat exchanger to effectuate a second temperature reduction, prior to reaching the expander;
a separator vessel connected to the expander, the separator vessel receiving a gas/liquid mix of the BOG stream from the expander;
a recirculation conduit connecting a gas outlet of the separator vessel to the gas-to-gas heat exchanger, wherein a recirculated BOG from the separator vessel acts as a cooling medium of the gas-to-gas heat exchanger to effectuate the second temperature reduction to cool the BOG stream to below −50° C. prior to entering the expander;
an oil-free low-pressure compression section for receiving the recirculated BOG, wherein the recirculated BOG exiting the oil-free low-pressure compression section is delivered to a second valve, the second valve controlling the flow of the recirculated BOG to the engine for consumption in a first configuration, and back to through the partial reliquefaction loop in a second configuration.

10. The partial reliquefaction system of claim 9, wherein a liquid portion of the gas/liquid mix is delivered to a LNG storage tank.

11. The partial reliquefaction system of claim 1, wherein the second temperature reduction is more than 100° C.

12. The partial reliquefaction system of claim 1, wherein a max system pressure is 60 bar.

13. The partial reliquefaction system of claim 1, wherein a max pressure at an inlet of the expander is below 60 bar.

14. The partial reliquefaction system of claim 1, wherein a portion of the BOG leaving the LNG storage tank is directed to pass through the heat exchanger before entering the BOG compression system, such that the BOG is pre-cooled before entering the BOG compressor.

15. A method for partial reliquefaction of a boil-off gas (BOG) on a liquified natural gas (LNG) carrier, the method comprising:
capturing the BOG exiting a LNG storage tank and delivering to a BOG compressor;
compressing a BOG stream delivered by the BOG compressor using a high-pressure compressor to increase a pressure and of the BOG stream;
reducing the temperature of the BOG stream using a heat exchanger;
directing the BOG stream to pass through an expander, which produces a gas/liquid mixture of the BOG stream;
separating a gas portion of the gas/liquid mixture from a liquid portion of the gas/liquid mixture in a separator vessel; and
recirculating the gas portion through the heat exchanger, such that a recirculated BOG acts as a cooling medium for the heat exchanger.

16. The method of claim 15, further comprising: directing a portion of the BOG leaving the LNG storage tank to pass through the heat exchanger before entering the BOG compressor, such that the BOG is pre-heated before entering the BOG compressor while providing additional pre-cooling before the expander.

17. The method of claim 15, wherein the method is performed at or below a system pressure of 60 bar.

18. The method of claim 15, further comprising: compressing the recirculated BOG using a low-pressure compressor.

19. The method of claim 15, further comprising: controlling a flow of the BOG stream, using a valve, to direct the BOG stream to an engine of the LNG carrier in a first configuration, and to the high-pressure compressor in a second configuration.

20. The method of claim 15, further comprising: controlling a flow of the recirculated BOG, using a valve, to direct the recirculated BOG to an engine of the LNG carrier in a first configuration, and to the high-pressure compressor in a second configuration.
